(19) United States
(12) Patent Application Publication
(10) Pub. No.: US 2008/0294689 A1
(43) Pub. Date: Nov. 27, 2008

(54) Credit Report Locking/Unlocking Via Telephone Interface

(75) Inventors: Scott Metzger, San Luis Obispo, CA (US); John Thomas Danaher, Hinsdale, IL (US)

Correspondence Address: Law Office of Mark J. Spolyar, 38 Fountain Street, San Francisco, CA, 94114, US

(73) Assignee: TransUnion Interactive, Inc., a Delaware corporation

(21) Appl. No.: 11/752,731

(22) Filed: May 23, 2007

(51) Int. Cl. G06F 17/30; G06Q 40/00

(52) U.S. Cl. 707/104.1

(57) ABSTRACT

The present invention, in particular embodiments, is directed to methods, apparatuses and systems directed to locking and unlocking of credit reports via a telephone interface. In a particular implementation, the present invention provides a voice interface server accessible to consumers via a telephone and a voice-based credit report access system. The voice-based credit report access system is operative to accept telephone requests to lock or unlock a credit report and pass those requests to a credit report retrieval system. When the request is received, the credit report retrieval system accordingly updates the consumer's entry in a lock status database. When the credit report retrieval system receives a credit report request, the lock status database is queried. If the consumer's entry has a locked status, the credit report is denied. If the status is unlocked, the credit report is provided to the requestor. In a particular implementation, a number of access attempts field of the consumer's entry is updated each time access to the credit report is denied while the credit report is locked.

### TECHNICAL FIELD

The present disclosure generally relates to credit report access systems and, more particularly, to locking and unlocking of credit reports via a telephone interface.

### BACKGROUND

Services providing credit reporting data to individual consumers are gaining widespread acceptance in light of increasing concern and attention to identity theft. Identity theft or fraud refers to crimes in which someone wrongfully obtains and uses another person's personal information, such as social security or financial account numbers, in a fraudulent or other deceptive manner for economic gain. Common activities associated with identity theft include opening credit card or other credit accounts using the victim's identity and charging against these accounts to purchase goods and services without the intention of paying off the ensuing debts.

Credit reporting services offer consumers the ability not only to gauge their personal credit standing, but also to monitor their credit histories for signs of identity theft. Such credit report providers typically offer their services over the Internet in light of the inherent advantages associated with ordering and viewing credit report information using a network-enabled client device, such as a personal computer.

Consumers are typically further provided with an ability to “lock” their credit report thus preventing third party from accessing the report. Locking a credit report may be desirous to do for a number of reasons. Some of these reasons include an occurrence of identity theft or perhaps a consumer who wishes to prevent routine third party access to his credit report.

Locking a credit report can be a cumbersome process, however Typically, the consumer contacts the various credit bureaus via postal mail and then potentially waits several days for the credit bureaus to lock the credit report as the actual locking is typically a manual procedure. In the interim, in the instance of identity theft, a consumer's credit standing may continue to falter as the credit report is still unlocked.

### SUMMARY

The present invention, in particular embodiments, is directed to methods, apparatuses and systems directed to locking and unlocking of credit reports via a telephone interface. In a particular implementation, the present invention provides a voice interface server accessible to consumers via a telephone and a voice-based credit report access system. The voice-based credit report access system is operative to accept telephone requests to lock or unlock a credit report and pass those requests to a credit report retrieval system. When the request is received, the credit report retrieval system accordingly updates the consumer's entry in a lock status database. When the credit report retrieval system receives a credit report request, the lock status database is queried. If the consumer's entry has a locked status, the credit report is denied. If the status is unlocked, the credit report is provided to the requestor. In a particular implementation, a number of access attempts field of the consumer's entry is updated each time access to the credit report is denied while the credit report is locked.

The following embodiments and aspects thereof are described and illustrated in conjunction with systems, apparatuses and methods which are meant to be exemplary and illustrative, not limiting in scope. In various embodiments, one or more of the above-described problems have been reduced or eliminated. In addition to the aspects and embodiments described above, further aspects and embodiments will become apparent by reference to the drawings and by study of the following descriptions.

### BRIEF DESCRIPTION OF THE DRAWINGS

Example embodiments are illustrated in referenced figures of the drawings. It is intended that the embodiments and figures disclosed herein are to be considered illustrative rather than limiting.

FIGS. 1A-1B are functional block diagrams illustrating a computer network environment including a voice-channel based credit application service, in accordance with an example embodiment;

FIG. 2 is a flowchart illustrating an authentication process flow, in accordance with an example embodiment;

FIG. 3 is a flowchart diagram illustrating a process flow directed to credit score reporting, in accordance with an example embodiment;

FIG. 4 is a schematic diagram illustrating a typical voice interface server architecture;

FIG. 5 is a flowchart diagram illustrating a method for locking and unlocking a credit report via a telephone interface, in accordance with an example embodiment;

FIG. 6 is a flowchart diagram illustrating a method for selectively delivering a credit report, in accordance with an example embodiment; and

FIG. 7 is a schematic diagram illustrating an example computing system architecture that may be used to implement one or more of client systems.

### DETAILED DESCRIPTION

The following embodiments and aspects thereof are described and illustrated in conjunction with systems, apparatuses and methods which are meant to be illustrative, not limiting in scope.

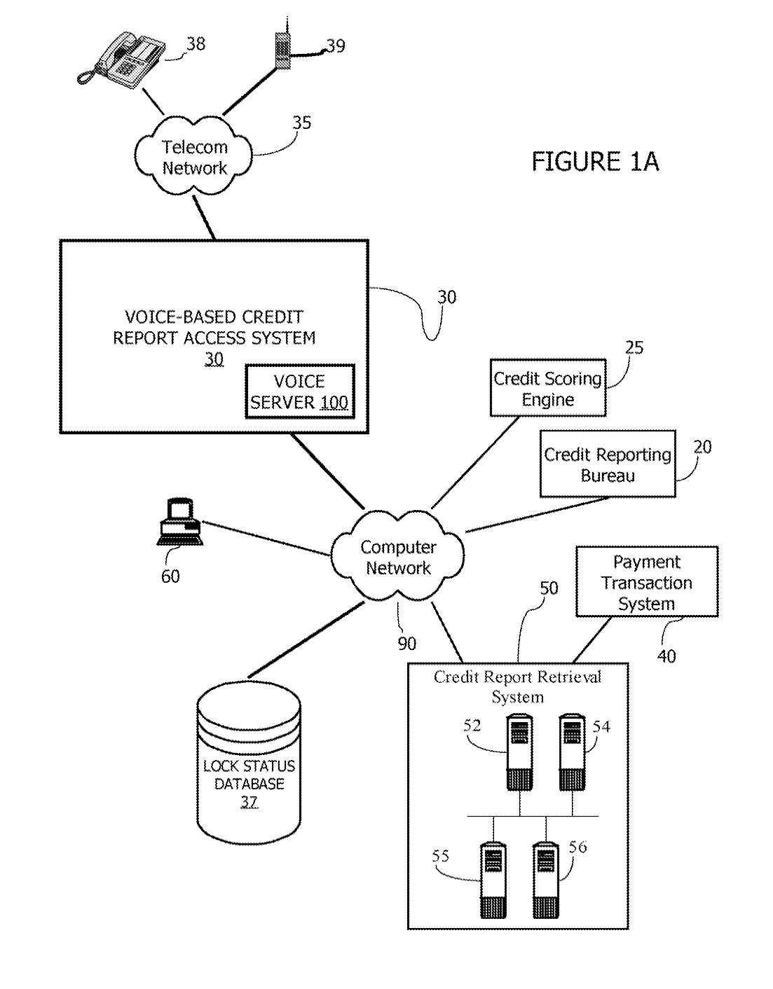

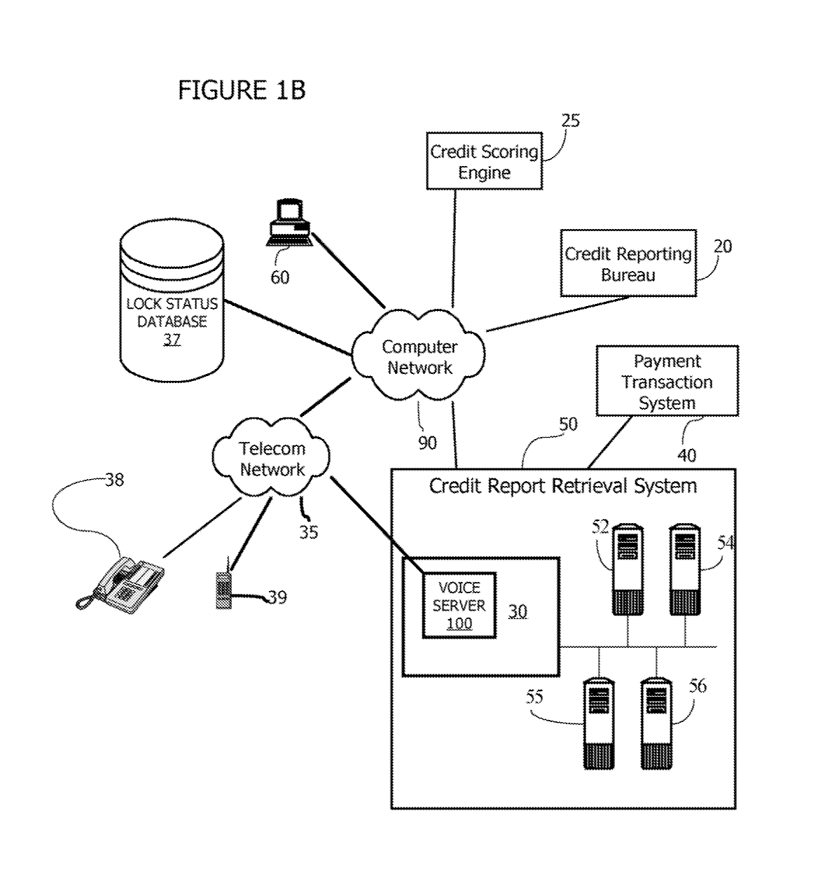

FIG. 1A is a functional block diagram illustrating a computer network environment that includes a voice-based credit report access system 30 which includes a voice interface server 100, telecommunications network 35, computer network 90, lock status database 37 and credit report retrieval system 50. Also included is a credit reporting bureau 20 a source of credit report information for creditors. In particular implementations, credit reporting bureau is a major credit reporting bureau, such as Transunion®. Other elements of FIG. 1A, such as the credit scoring engine 25 for example, will be described in subsequent sections. A consumer may lock and unlock his credit report by calling, via a telephone (38, 39), the voice-based credit report access system 30 via the telecommunications network 35. After the consumer's identity is authenticated by the voice-based credit report access system 30, the consumer may select menu options to lock or unlock their credit report, amongst other functionalities. After the voice-based credit report access system 30 receives the consumer's selection, the voice-based credit report access system 30 updates an entry of the consumer in the lock status database 37. Other implementations are possible. Although FIG. 1A illustrates the voice-based credit report access system 30 and credit report retrieval system 50 as separate systems, they may be collocated or hosted by the same domain such as the implementation illustrated in FIG. 1B. Furthermore, the functionality of the voice-based credit report access system 30 and voice interface server 100 may be incorporated into one or more of credit reporting bureaus 20.

When the credit report retrieval system 50 receives a credit report request from a consumer, the lock status database 37 is queried. Restated, others, such as lenders, obtain credit reports directly from the credit reporting bureau 20. If the corresponding entry has a locked status, the credit report retrieval system 50 denies the credit report request. If the status is unlocked, the credit report retrieval system 50 delivers the credit report to the requestor. The lock status database 37 can reside at various locations. For example, it might be at a separate location from the voice-based credit report access system 30 and the credit report retrieval system 50, as shown in FIG. 1A or 1B. Alternatively, it may be located at the voice-based credit report access system 30 or at the credit report retrieval system 50. Still further, credit reporting bureau 20 may cache one or more entries of the lock status database 37. In one implementation, the time period after which a cached entry is invalid can be selected based on a variety of considerations. In the implementation described, credit report retrieval system 50, whether in conjunction with voice-based credit report access system 30 or separately, is primarily oriented around providing aggregated or individual credit reports to the consumers that are the subject of their respective reports. Third parties, such as lenders, obtain credit reports corresponding to particular entities directly from the credit reporting bureau 20.

Typical fields in the lock status database 37 are name, address, Social Security number and lock status. In one implementation, additional fields may be included such as a total number of denied requests while the report is locked, total number of successful requests while the report is unlocked, who requested the report, timestamp, etc.

The voice interface server 100 can function as an interactive voice unit (“IVR”) or as a voice recognition unit (“VRU”). An example server architecture that can function as the IVR and the VRU will be presented in a subsequent section.

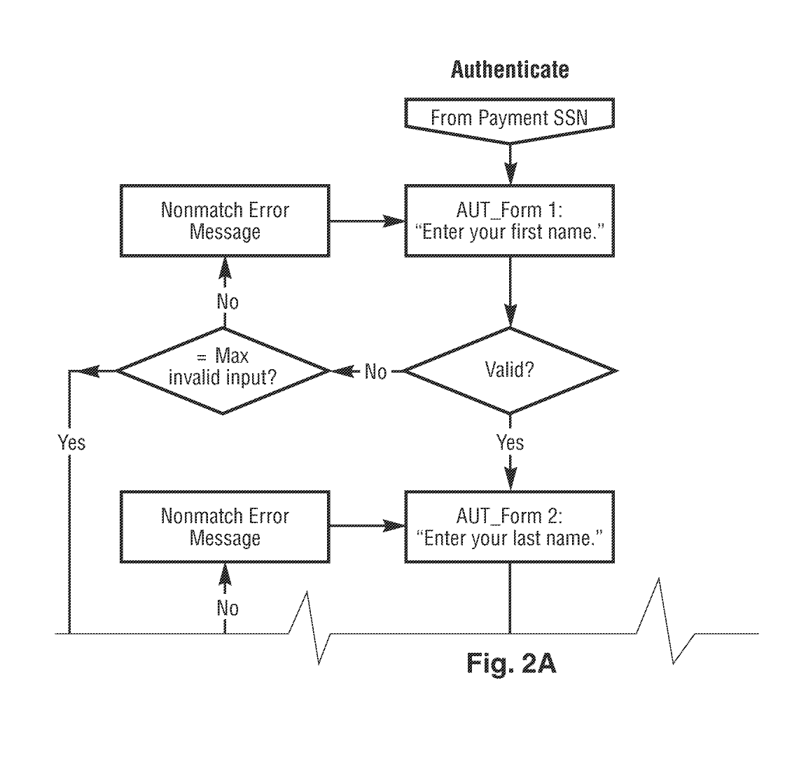

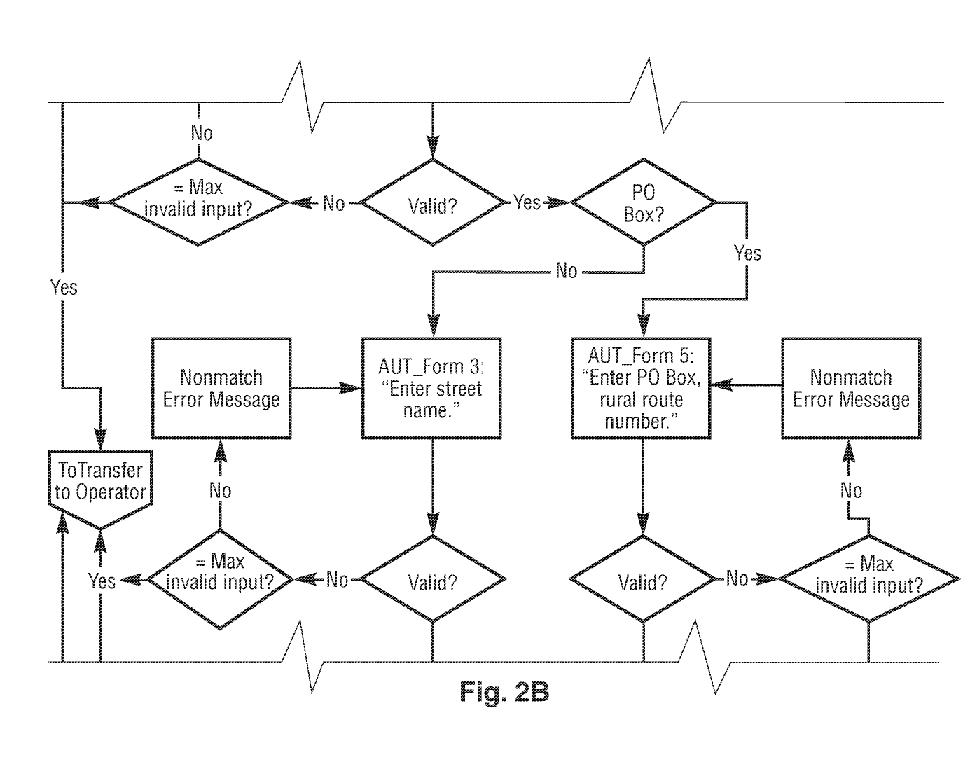

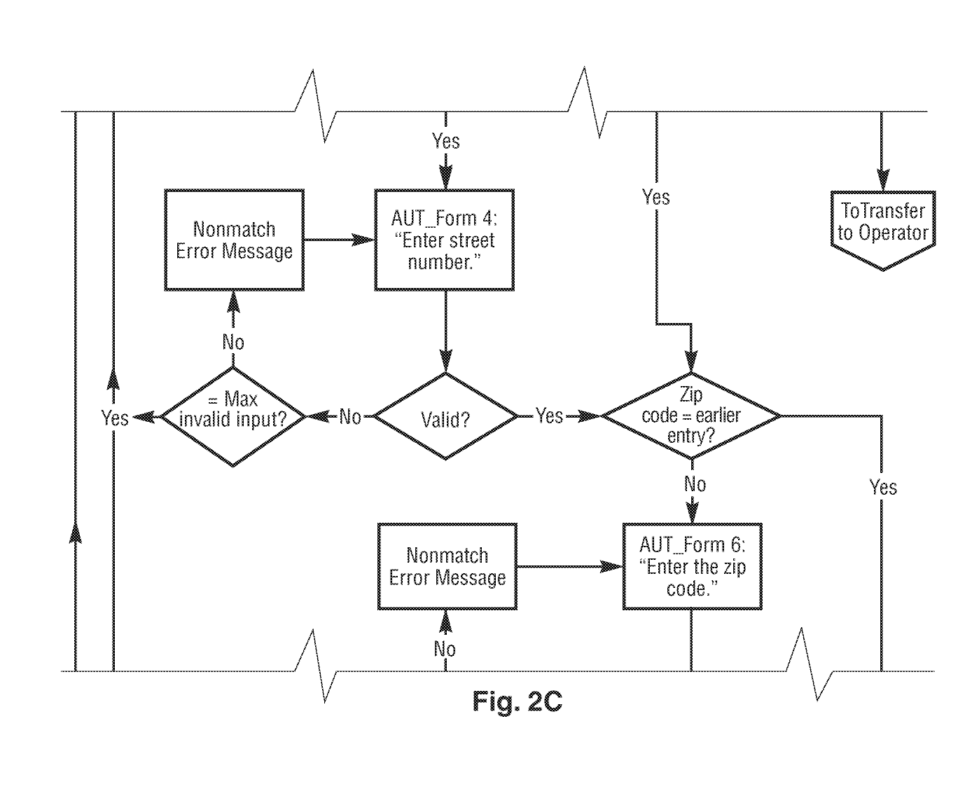

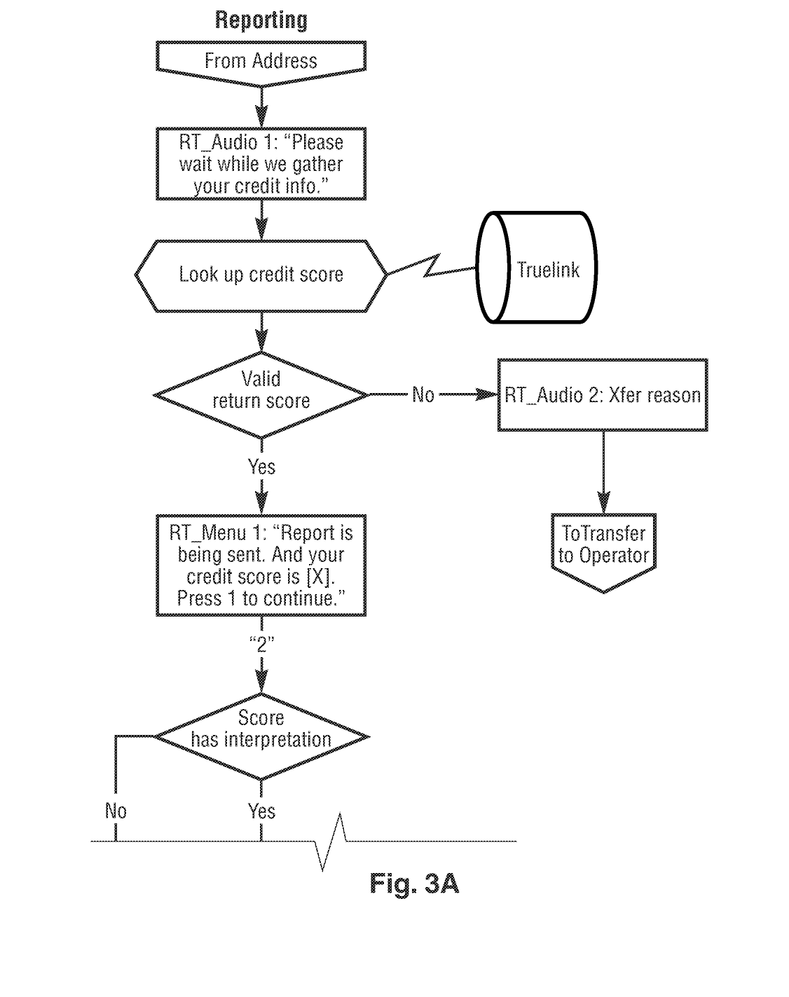

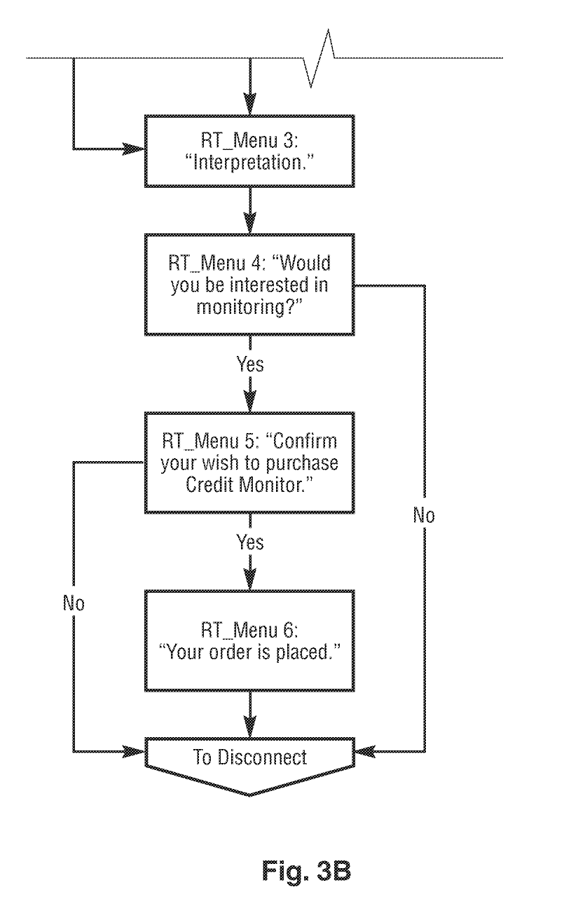

In some implementations, a consumer may send a request for their credit report, from the telephone (38, 39) to the voice-based credit report access system 30. In turn, the voice-based credit report access system 30 obtains the credit report from the credit report retrieval system 50 and related systems will now be described in more detail. Additionally, FIG. 2 illustrates an authentication process flow, in accordance with an example embodiment and FIG. 3 sets forth a process flow, in accordance with an example embodiment, directed to the credit reporting aspect of the present invention.

The credit data retrieval system 50 comprises Web/HTTP server 52, application server 54, database server 56 and web services network gateway 55. Web/HTTP server 52 is operative to establish HTTP or other connections with client computers (or other network access devices) to receive requests for files or other data over computer network 90 and transmit responses in return. In one embodiment, Web/HTTP server 52 passes consumer requests to application server 54 which composes a response and transmits it to the consumer via web server 52. In one embodiment, web server 52 establishes a secure connection to transmit data to consumers and other sites, using the SSL (“Secure Sockets Layer”) encryption protocol part of the HTTP(S) (“Secure HTTP”) protocol, or any other similar protocol for transmitting confidential or private information over an open computer network. Database server 56 stores the content and other data associated with operation of loan rate analysis system. Application server 54, in one embodiment, includes the functionality handling the overall process flows, described herein, associated with credit data retrieval system 50. Application server 54, in one embodiment, accesses database server 56 for data (e.g., HTML page content etc.) to generate responses to consumer requests and transmit them to web server 52 for ultimate transmission to the requesting consumer. Application server 54 is further operative to interact with the voice-based credit report access system 30 through, in one embodiment, network 0 services gateway 55 to allow consumers to access credit reports with voice-based telephone network devices, such as cell phones, POTS telephones, and web phones, as discussed below. As one skilled in the art will recognize, the distribution of functionality set forth above among web server 52, database server 56 and application server 54 is not required by any constraint. The functionality described herein may be included in a single logical server or module or distributed in separate modules. In addition, the functionality described herein may reside on a single physical server or across multiple physical servers.

Credit scoring engine 25, in one embodiment, is a web-based application service operative to compute a credit score given a set of credit data. Credit scoring engine 25 is operative to receive credit report data relating to an individual or other entity and process the data against a proprietary or other credit scoring model to yield a credit score Suitable credit scoring models including a FICO® credit scoring model, CreditXpert®, TransRisk®, or any other suitable credit scoring model. In one embodiment, credit scoring engine 25 is a stand-alone web-based application remote from credit data retrieval system 50 and/or credit reporting bureau 20. In other embodiments, the functionality of credit scoring engine 25, however, is integrated into other components associated with computer network 90. For example, credit scoring engine 25 may be incorporated as an internally executed application (such as CreditXpert) within credit data retrieval system 50, or within credit reporting bureau 20.

Credit reporting bureau 20 maintains a database or other repository of credit history data for at least one individual or other entity, such as the credit reporting services offered by Experian®, Equifax™, and TransUnion®. Credit reporting bureau(s) 20 offer web-based credit reporting application services. Credit reports are available to the entities that are the subject of the reports (such as individual consumers), as well as third parties (such as lenders and other potential creditors) making credit decisions involving these entities. In one embodiment, at least one credit reporting bureau 20 includes Address Verification System (AVS) functionality, allowing for verification of addresses associated with individual consumers. In one embodiment, credit data retrieval system 50 formulates an XML request and transmits it to credit reporting bureau 20 to retrieve credit report data. In one embodiment, at least one credit reporting bureau 20 is operative to access credit scoring engine 25 in response to a request from credit data retrieval system 50; in such an embodiment, the credit reporting bureau 20 transmits the credit reporting data associated with the individual to credit scoring engine 25 and receives a credit score in return. The credit reporting bureau 20 then returns the credit score with the credit report data to credit data retrieval system 50. In one embodiment, credit data retrieval system 50 formulates an XML request and transmits it to credit reporting bureau 20 to retrieve credit report data. In one embodiment the XML request format includes a flag or other indication of whether a credit score is also desired. Credit reporting bureau 20 responds to the asynchronous or synchronous request by transmitting an XML response including credit report data corresponding to the individual identified in the XML request In one embodiment, credit data retrieval system 50 operates in connection with one credit reporting bureau, such as TransUnion, Equifax, and Experian; however, in other embodiments, credit data retrieval system 50 obtains credit report data for a particular individual from at least two credit reporting bureaus 20 and merges the data into a single report. Co-pending and commonly owned application Ser. No. 09/644,139 filed Aug. 22, 2000 in the name of Guy et al. and entitled “Credit and Financial Information and Management System” discloses methods and systems that obtain credit report data from multiple sources and merge such data into a single report (incorporated by reference herein).

Payment transaction system 40 corresponds to a payment transaction processing network associated with one of a plurality of different non-cash payment mechanisms, such as credit card or debit card. According to one embodiment, the transaction processing network can be a credit card or debit card transaction processing network, such as VISA®, MASTERCARD®, DISCOVER®, or AMERICAN EXPRESS®. In one embodiment, the transaction processing networks enable consumers, at telephone 38 or 39, to provide a non-cash method of payment, which credit data retrieval system 50 uses to obtain payment according to well known transaction processing protocols.

As described below, credit data retrieval system 50 is operative to interact directly with the voice-based credit report access system 30 to receive requests from consumers at telephones 38 or 39. Credit data retrieval system 50 is further operative to pull credit report data from one or more credit reporting bureaus 20, provide credit scores to consumers, and, in one embodiment, trigger a mailing system to print out and mail hard copies of credit reports to respective consumers. Credit data retrieval system 50 is also operative to allow users to lock and unlock access to their credit reports. In one embodiment, credit data retrieval system 50 includes web/HTTP server 52 operative to receive requests from consumers and transmit responses in return. Credit data retrieval system 50 further includes network services gateway 55 which implements web services network functionality to process and route service requests and responses over a computer network. In one embodiment, network services gateway 55 implements a communications model based on requests and responses. Network services gateway 55 generates and transmits a service request to an external vendor, such as credit reporting bureau 20 and/or credit scoring engine 25, which receives the request, executes operations on data associated with the request, and returns a response. Network services gateway 55, in one embodiment, further includes other web services functionality such as logging of service requests and responses allowing for tracking of costs and usage of services.

Network services gateway 55, in one embodiment, rely on secure HTTP communications and XML technologies for request and response formats. In one embodiment, the network services gateway 55 maintain Document Type Definitions (DTDs) and/or schemas that define the format of the XML request and XML response. Request and response DTDs, in one form, include a message type, transaction identification, vendor/service identification, and an application identification.

As one skilled in the art will recognize various embodiments are possible. For example, the credit retrieval functionality of system 50 may be incorporated into the functionality of credit reporting bureau 20. In one embodiment, consumers may also access credit data retrieval system 50 over computer network 90 with a network access device, such as client computer 60 including suitable client software, such as a web browser. However, suitable network access devices include desktop computers, laptop computers, Personal Digital Assistants (PDAs), and any other wireless or wireline device capable of exchanging data over computer network 90 and providing a consumer interface displaying data received over computer network 90. In one embodiment, computer network 90 is the Internet; however, computer network 90 may be any suitable wide-area network.

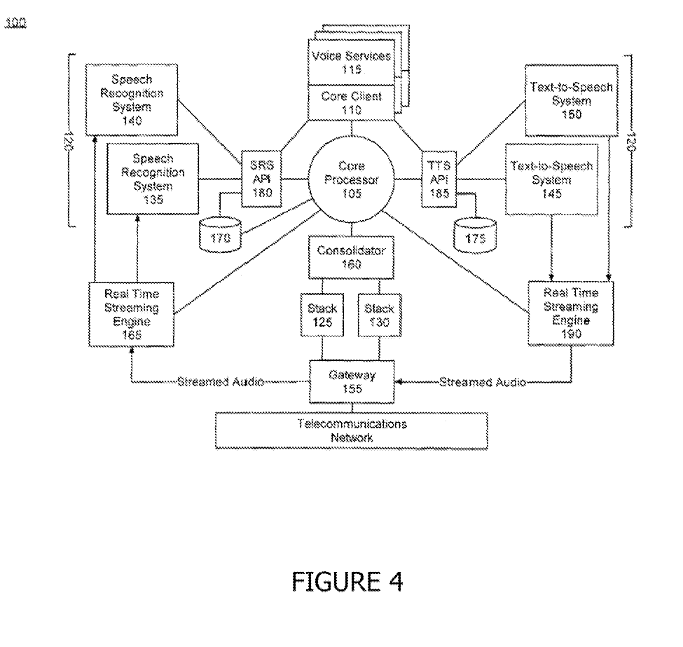

As previously mentioned, the voice interface server 100 can perform the functions of an IVR and a VRU. With that in mind, a typical voice interface server architecture will now be presented via FIG. 4. As shown, the voice interface server 100 can include a core processor 105, one or more core clients 110 and accompanying voice services 115, speech resources 120, and network stacks 125 and 130. Communications between the various components of the voice interface server 100 can be facilitated through a suitable packet-based network communications protocol such as Transmission Control Protocol/Internet Protocol (TCP/IP).

The core processor 105 can communicate with and coordinate the operation of the various components of the voice interface server 100. The core processor 105 can process telephony signaling information for calls, perform lookup functions to determine services associated with received calls, as well as allocate resources required for processing a telephone call. For example, the core processor 105 can identify available core clients 110 for processing a telephone call as well as allocate speech processing resources.

Although the core processor 105 can receive telephony signaling information, audio or speech data for calls is not routed through the core processor 105. The core processor 105 does, however, include lookup services for querying data stores to determine telephony related information for a caller or call. Generally, lookup services enable communications over a network. As such, the core processor 105 can use a lookup protocol to obtain information regarding remote programs or machines and use that information to establish a communications link.

Each of the core clients 110 can serve as an interface between the core processor 105 and a voice service 115. One core client 110 can be allocated per voice service 115. The core clients 110 can store call models for both incoming and outgoing calls. The core clients can fetch and execute voice services as required for processing a given call. The core clients 110 can include virtual machines. Alternatively, the core clients 110 can be associated with or instantiate one or more virtual machines, such as voice browsers, in which the voice services can be executed. The voice service 115, upon execution, can provide interactive access to a caller as well as interface with any enterprise applications as may be required. Notably, the voice service 115, once executing, can interact with the core processor 105 via the core client 110 to instruct the core processor 105 as to where to route the speech data for telephone calls. The core client 110 can include a defined application programming interface (API) which facilitates communication between the voice services 115 and the core client 110.

The speech processing resources 120 of the voice interface server 100 can include speech recognition systems 135 and 140 as well as text-to-speech (TTS) systems 145 and 150. The speech recognition systems 135 and 140 can convert received speech to text. The TTS systems 145 and 150 can convert text to speech to be played to a caller. The speech recognition system 135 and the TTS system 145 can be c incorporated into or provided as part of the voice interface server 100, while the speech recognition system 140 and the US system 150 can be third-party systems which can be added to or work cooperatively with the voice interface server 100.

The voice interface server 100 can be communicatively linked to a circuit-switched telecommunications network via a gateway 155 which serves as an interface between the telecommunications network and packet-switched network. More particularly, the gateway 155 can receive telephony information including telephony signaling information and audio or speech information over TI links, integrated services digital network (ISDN) links, and/or channel associated signaling (CAS) links. The gateway 155 can separate telephony signaling information from the speech and/or audio data, as well as combine the two for transmission over the telecommunications network. Audio information for received calls can be converted to one or more streams of audio formatted in a suitable protocol such as Real-Time Transport Protocol. Similarly, one or more channels of streamed audio can be received in the gateway 155 and format converted for transmission over the telecommunications network.

The telephony signaling information can be converted from a circuit-switched format to a packet-switched format and paced on an appropriate stack conforming to one of multiple supported communications protocols. For example, received signaling information can be placed on the stack 125 conforming to an H.323 stack or the stack 130 conforming to a Session Initiation Protocol (SIP) stack. Notably, both stacks 125 and 130 can be implemented as lava stacks. The consolidator 160 can serve as an interface between any protocol stacks and the core processor 105. Accordingly, through the consolidator 160, the core processor 105 can receive or read telephony signaling information from the stacks 125 and 130 as well as write telephony signaling information back to the stacks 125 and 130.

In operation, the gateway 155 can receive an inbound call. As mentioned, the telephony signaling information can be separated from the audio information. Accordingly, the gateway 155 can format the received telephony signaling information for use with a packet-switched network and place the telephony signaling information on an appropriate stack such as the H.323 stack or the SIP stack. The consolidator 160 can take events from the stacks 125 and 130 and provide the telephony signaling information to the core processor 105 via a TCP/IP connection.

Audio information from the inbound call can be format converted by the gateway 155 into a channel of streamed audio which can be routed to the real time streaming (RTS) engine 165. The real time streaming engine 165 can coordinate one or more channels of streaming audio, synchronize the channels, as well as link one or more of the streaming audio channels to the speech recognition system 135 or 140 for conversion to text.

The core processor 105, having received the telephony signaling information for the inbound call can perform one or more functions. As the telephony signaling information can specify the called number and the calling number, the core processor 105 can query the data store 170 and/or 175 to determine one or more voice services to be implemented as well as any voice interface server resources 120 that may be required to process the call. The data stores 170 and 175 can include associations of telephony signaling data and voice services, references to voice services, as well as a listing of voice interface server resources required to implement the voice services. As shown in FIG. 4, the core processor 105 can query the data store 170 directly or can query the data stores via an appropriate interface such as API 180 and/or 185.

The core processor 105, having determined one or more voice services 115 to be executed for processing the inbound call, can allocate the necessary voice interface server resources 120. For example, the core processor 105 can identify an idle core client 110 which is not being used by a voice service 115. The core processor 105 can pass the identified core client 115 the called number, the calling number, information describing the resources which have been allocated for processing the inbound call, as well as the services which are associated with the call.

The core client 110 can fetch the designated voice services, for example from another data store or an application server, and execute the voice service. The voice service determines whether the call will be accepted. If so, the voice service signals the core processor 105 via the core client 110, to accept the call and to route the voice channel to the appropriate speech processing device. Audio received via the inbound call can be processed by the speech recognition system 135 and can be routed to the voice service 115 as text strings. The speech recognition systems 135 and 140 can communicate with the core processor 105 and the core clients 110 via the speech recognition system API 180 as shown. Notably, the speech recognition system 135, being integrated into the voice interface server 100, can include an additional interface, such as an application toolkit providing further functionality for the speech recognition system 135.

The voice service 115 also can send text, whether generated by the voice service or obtained from another enterprise application, to the TTS system 145. Similar to the speech recognition systems, the core processor 105 and the core client 110 can communicate with the TTS system 145 via the TTS API 185. Additionally, as the TTS system 145 is integrated into the voice interface server 100, the TTS system 145 can include an additional interface, such as an application toolkit providing further functionality for the TTS system 145. Accordingly, text which is converted to speech via the TTS system 145 and/or 150, can be provided to the RTS engine 190. The RTS engine 190 can receive speech from the TTS systems 145 and 150, and convert the received audio into one or more channels of streamed audio. As was the case with the RTS Engine 165, the RTS engine 190 can coordinate one or more channels of streaming audio, synchronize the channels, and provide the streaming audio channels to the gateway 155.

The gateway 155 can receive the streaming audio channels and convert the audio into a format suitable for transmission over the telecommunications network. Notably, the audio can be routed according to telephony signaling information provided to the gateway 155 by the core processor 105 via the consolidator 160 and the stacks 125 and 130.

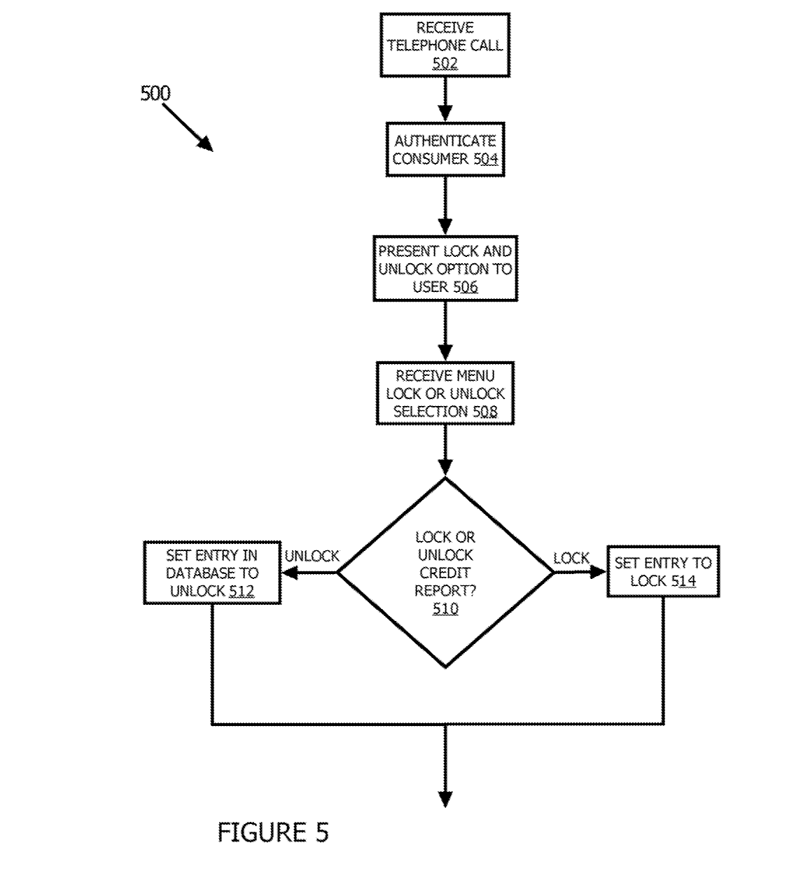

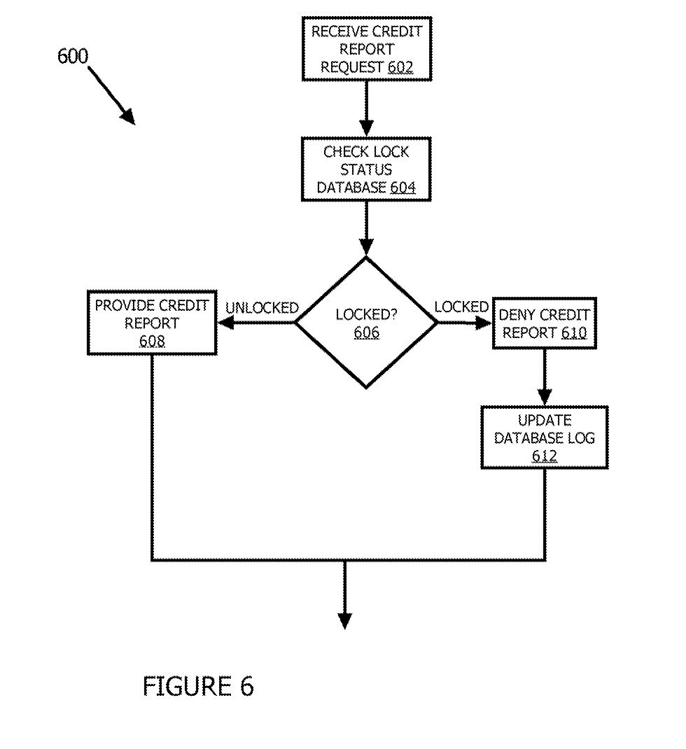

To further illustrate the claimed embodiments, flowchart diagrams of FIGS. 5-6 will now be presented The flowchart diagram of FIG. 5 illustrates a method 500 utilized by the credit report retrieval system 50 for updating an entry in the lock status database 37. It should be noted that method 500 is being presented in the context of the embodiment of FIG. 1B where the voice-based credit report access system 30 and the voice interface server 100 are integrated into the credit report retrieval system 50. First, the credit application service 30 receives a telephone call (502) and authenticates the identity of the consumer (504). Next, the credit report retrieval system 50 presents credit report lock and unlock menu options (506) to the consumer. One skilled in the art will readily recognize that this is merely exemplary as other options may also be presented to the consumer as well as, perhaps, intervening menu options.

The credit report retrieval system 50 then receives the selected menu option (508). If unlock was selected (510), the credit report retrieval system 50 sets an entry (512), corresponding to the consumer, in the lock status database 37 to “unlocked.” if lock was selected (510), the c credit report retrieval system 50 sets an entry (512) in the lock status database 37 to “locked.”

FIG. 6 illustrates a flowchart diagram of a method 600 for processing a request for a credit report at the credit report retrieval system 50. After receiving a credit report request (602), the credit report retrieval system 50 checks (604) an entry in the lock status database 37 corresponding to the requested credit report. If the entry is not locked (606) then the credit report retrieval system 50 delivers the requested credit report (608). If the entry is locked (606) then the credit report retrieval system 50 denies access to the credit report (410) and updates (412) the database 37 with information pertaining to the denied request Operation 612 is optional. Additionally, operation 412 can additionally be performed after operation 608.

As previously indicated, the information pertaining to denied requests, and perhaps allowed requests can include a total number of denied requests while the report is locked, total number of successful requests while the report is unlocked, who requested the report, timestamp etc.

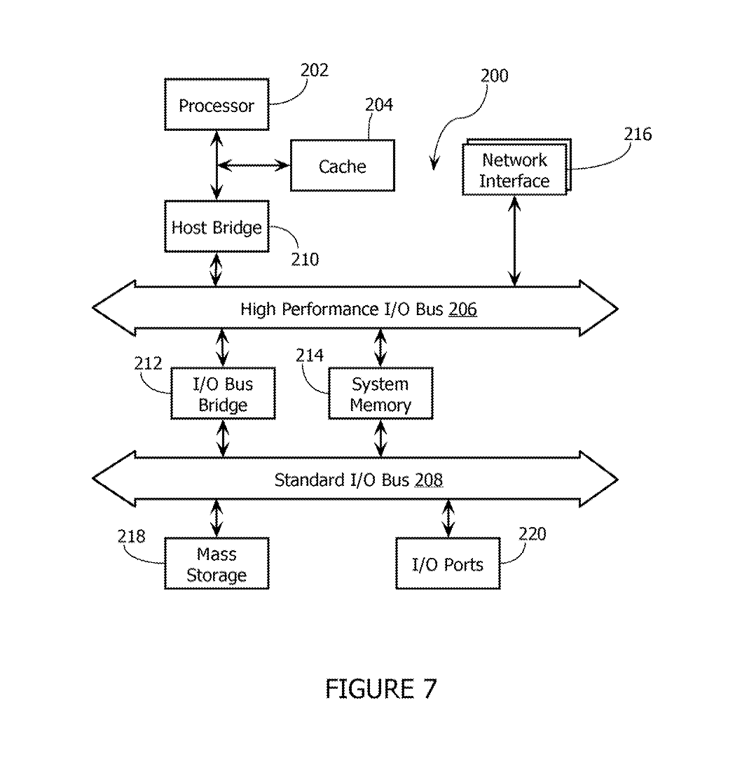

While the methods of the claimed embodiments have been described above with reference to specific embodiments, some or all of the elements or operations thereof may be implemented using a computer system having a general purpose hardware architecture such as the one in FIG. 7 which illustrates an example hardware system 200. In one implementation, hardware system 200 comprises a processor 202, a cache memory 204, and one or more software applications and drivers directed to the functions described herein. In one implementation, hardware system 200 includes a high performance input/output (I/O) bus 206 and a standard I/O bus 208. A host bridge 210 couples processor 202 to high performance I/O bus 206, whereas I/O bus bridge 212 couples the two buses 206 and 208 to each other. A system memory 214 and one or more network/communication interfaces 216 couple to bus 206. Hardware system 200 may further include video memory (not shown) and a display device coupled to the video memory Mass storage 218 and I/O ports 220 couple to bus 208. A variety of memory management and caching schemes can be used. Hardware system 200 may optionally include a keyboard and pointing device (not shown) coupled to bus 208. Collectively, these elements are intended to represent a broad category of computer hardware systems, including but not limited to general purpose computer systems based on the Pentium® processor manufactured by Intel Corporation of Santa Clara, Calif., as well as any other suitable processor.

Network interface 216 provides communication between hardware system 200 and any of a wide range of networks, such as an Ethernet (e.g., IEEE 802.3) network, etc. Mass storage 218 provides permanent storage for the data and programming instructions to perform the above described functions implemented in the system controller, whereas system memory 214 (e.g., DRAM) provides temporary storage for the data and programming instructions when executed by processor 202. I/O ports 220 are one or more serial and/or parallel communication ports that provide communication between additional peripheral devices, which may be coupled to hardware system 200.

Hardware system 200 may include a variety of system architectures; and various components of hardware system 200 may be rearranged. For example, cache 204 may be on-chip with processor 202. Alternatively, cache 204 and processor 202 may be packed together as a “processor module,” with processor 202 being referred to as the “processor core.” Furthermore, certain implementations of the present invention may not require nor include all of the above components. For example, the peripheral devices shown coupled to standard I/O bus 208 may couple to high performance I/O bus 206. In addition, in some implementations only a single bus may exist, with the components of hardware system 200 being coupled to the single bus. Furthermore, hardware system 200 may include additional components, such as additional processors, storage devices, or memories.

The operations of the claimed embodiments may be implemented as a series of software routines run by hardware system 200. These software routines comprise a plurality or series of instructions to be executed by a processor in a hardware system, such as processor 202. Initially, the series of instructions are stored on a storage device, such as mass storage 218. However, the series of instructions can be stored on any suitable storage medium, such as a diskette, CD-ROM, ROM, EEPROM, etc. Furthermore, the series of instructions need not be stored locally, and could be received from a remote storage device, such as a server on a network, via network/communication interface 216. The instructions are copied from the storage device, such as mass storage 218, into memory 214 and then accessed and executed by processor 202.

An operating system manages and controls the operation of hardware system 200, including the input and output of data to and from software applications (not shown). The operating system provides an interface between the software applications being executed on the system and the hardware components of the system. According to one embodiment of the present invention, the operating system is the Windows® 95/98/NT/XP/Vista operating system, available from Microsoft Corporation of Redmond, Wash. However, the present invention may be used with other suitable operating systems, such as the Apple Macintosh Operating System, available from Apple Computer Inc of Cupertino, Calif., UNIX operating systems, LINUX operating systems, and the like.

While a number of exemplary aspects and embodiments have been discussed above, those of skill in the art will recognize certain modifications, permutations, additions and sub-combinations thereof. Accordingly, it is therefore intended that the following appended claims and claims hereafter introduced are interpreted to include all such modifications, permutations, additions and sub-combinations as are within their true spirit and scope.

What is claimed is:

1. A telephone-based credit report lock/unlock system comprising:
a voice-based credit report access system operably connected to a telecommunications network to transmit voice signals to and receive voice signals or dual-tone modulation frequency (“DTMF”) tones from voice-based telephone network devices wherein the voice interface server includes call process flow functionality operative to interact with consumers and receive signals to lock and unlock credit reports in a lock status database; and
a credit report retrieval system operative to interact with the voice interface server to receive the signals to lock and unlock the credit reports and further operative to modify entries in the lock status database based on the received signals.

2. The system as recited in claim 1 wherein the voice-based credit report access system is integrated with the credit report retrieval system.

3. The system as recited in claim 1 wherein the call process flow functionality is operative to:
prompt for and receive information identifying an individual user;
transmit the information to the credit report retrieval system in a message requesting authentication information;
authenticate the user based on the authentication information provided by the credit report retrieval system.

4. The system as recited in claim 3 wherein the call process flow functionality is further operative to:
notify the credit report retrieval system of successful and failed authentication attempts; and
provide credit report scores returned from the credit report retrieval system to authenticated users.

5. The system as recited in claim 3 further comprising an address verification system operative to return an address associated with an individual user; and wherein the credit report retrieval system, in response to a request including information identifying a user, is operative to retrieve, from the address verification system, an address associated with the user and transmit the address to the voice-based credit report access system; and wherein the voice-based credit report access system authenticates the user based on the transmitted address.

6. The system as recited in claim 4 wherein the credit report retrieval system is further operative to begin processing retrieval of credit report data associated with the user from a credit reporting bureau in response to the request for authentication information; and wherein the credit report retrieval system is operative to terminate the processing in response to a notification that the user has failed authentication.

7. In a credit data retrieval system, a method for locking and unlocking a credit report comprising:
receiving a credit report request;
checking an entry, related to the credit report request, in a lock status database;
delivering a credit report if the entry has an unlocked status;
refusing delivery of the credit report if the entry has a locked status; and
wherein the locked and unlocked statuses can be set by a consumer via a telephone interface.

8. The method as recited in claim 7 further comprising updating a field in the entry when delivery of the credit report is refused.

9. The method as recited in claim 8 wherein the field is a total number of denied credit report requests.

10. The method as recited in claim 7 further comprising updating a field in the entry when the credit report is delivered.

11. The method as recited in claim 10 wherein the field is a total number of allowed credit report requests.

12. The method as recited in claim 7 further comprising receiving signals to modify the entry in the lock status database to a locked or unlocked status.
